(19) United States
(12) Patent Application Publication
(10) Pub. No.: US 2026/0368226 A1
(43) Pub. Date: Nov. 19, 2026

(54) CONTRACT SUPPORT DEVICE, CONTRACT SUPPORT METHOD, AND STORAGE MEDIUM

(71) Applicant: NEC Corporation, Tokyo (JP)

(72) Inventors: Shingo MORIGAKI, Tokyo (JP); Marina Adachi, Tokyo (JP); Toshihiko Imai, Tokyo (JP); Wataru Takayanagi, Tokyo (JP); Kentaro Maeda, Tokyo (JP)

(73) Assignee: NEC Corporation, Tokyo (JP)

(21) Appl. No.: 19/645,442

(22) Filed: Apr. 13, 2026

(30) Foreign Application Priority Data
May 16, 2025 (JP) 2025-082727

(51) Int. Cl. G06F 16/334; G06Q 50/18

(52) U.S. Cl. CPC G06F 16/3344; G06Q 50/18

(57) ABSTRACT

A contract support device according to an aspect of the present disclosure includes: at least one memory storing a set of instructions; and at least one processor configured to execute the set of instructions to: receive information on a negotiation partner and information on a draft contract, the negotiation partner being a counterpart in negotiation for a contract of a negotiator, the draft contract being a draft of details of the contract with the negotiation partner; extract, from among past contract documents, the past contract document in which a level of a degree of similarity satisfies a criterion; and output information on the extracted past contract document.

### CROSS-REFERENCE TO RELATED APPLICATION

This application is based upon and claims the benefit of priority from Japanese Patent Application No. 2025-082727, filed on May 16, 2025, the disclosure of which is incorporated herein in its entirety by reference.

### TECHNICAL FIELD

The present disclosure relates to a contract support device, a contract support method, and a program.

### BACKGROUND ART

WO 2024/057589 A1 describes a correction suggesting system that, based on post-correction information that is a post-correction item obtained by correcting a pre-correction item, provides correction suggesting information regarding suggestion of correction for a target item in a second contract document, which is different from a first contract document.

### SUMMARY

An object of the present disclosure is to provide a contract support device, a contract support method, and a program capable of providing information that may improve a possibility that a counterparty to a contract accepts a modification of the contract.

A contract support device according to an aspect of the present disclosure includes: at least one memory storing a set of instructions; and at least one processor configured to execute the set of instructions to: receive information on a negotiation partner and information on a draft contract, the negotiation partner being a counterpart in negotiation for a contract of a negotiator, the draft contract being a draft of details of the contract with the negotiation partner; extract, from among past contract documents, the past contract document in which a level of a degree of similarity satisfies a criterion, each of the past contract documents being a contract document of another contract with a contract partner related to the negotiation partner among contract partners with which the negotiator has already concluded the another contract, the degree of similarity representing a level of similarity between a content of the past contract document and a content of the draft contract; and output information on the extracted past contract document.

A negotiation support method according to an aspect of the present disclosure includes: receiving information on a negotiation partner and information on a draft contract, the negotiation partner being a counterpart in negotiation for a contract of a negotiator, the draft contract being a draft of details of the contract with the negotiation partner; extracting, from among past contract documents, the past contract document in which a level of a degree of similarity satisfies a criterion, each of the past contract documents being a contract document of another contract with a contract partner related to the negotiation partner among contract partners with which the negotiator has already concluded the another contract, the degree of similarity representing a level of similarity between a content of the past contract document and a content of the draft contract; and outputting information on the extracted past contract document.

A non-transitory computer readable storage medium according to an aspect of the present disclosure stores a program for causing a computer to execute: contract information receiving processing of receiving information on a negotiation partner and information on a draft contract, the negotiation partner being a counterpart in negotiation for a contract of a negotiator, the draft contract being a draft of details of the contract with the negotiation partner; past information extraction processing of extracting, from among past contract documents, the past contract document in which a level of a degree of similarity satisfies a criterion, each of the past contract documents being a contract document of another contract with a contract partner related to the negotiation partner among contract partners with which the negotiator has already concluded the another contract, the degree of similarity representing a level of similarity between a content of the past contract document and a content of the draft contract; and output processing of outputting information on the extracted past contract document.

### BRIEF DESCRIPTION OF THE DRAWINGS

FIG. 1 is a block diagram illustrating an example of a configuration of a contract support device according to the present disclosure;

FIG. 2 is a flowchart illustrating an example of an operation of the contract support device according to the present disclosure;

FIG. 3 is a block diagram illustrating an example of a configuration of a contract support device according to the present disclosure;

FIG. 4 is a flowchart illustrating an example of an operation of the contract support device according to the present disclosure;

FIG. 5 is a flowchart illustrating an example of an operation of the contract support device according to the present disclosure;

FIG. 6 is a block diagram illustrating an example of a configuration of a contract support device according to the present disclosure;

FIG. 7 is a flowchart illustrating an example of an operation of the contract support device according to the present disclosure;

FIG. 8 is a block diagram illustrating an example of a configuration of a contract support device according to the present disclosure;

FIG. 9 is a flowchart illustrating an example of an operation of the contract support device according to the present disclosure; and

FIG. 10 is a diagram illustrating an example of a hardware configuration of a computer capable of implementing the contract support device according to the present disclosure.

### EXAMPLE EMBODIMENT

Hereinafter, example embodiments of the present disclosure will be described in detail with reference to the drawings.

### First Example Embodiment

First, a first example embodiment of the present disclosure will be described in detail with reference to the drawings.

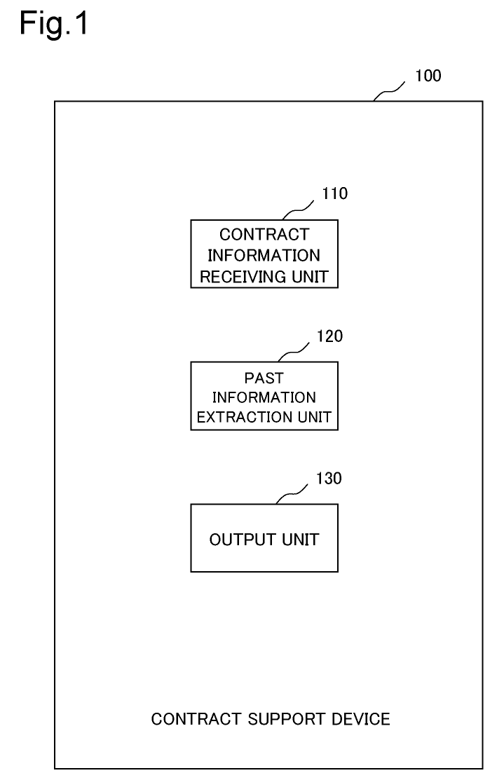

FIG. 1 is a block diagram illustrating an example of a configuration of a contract support device according to the present disclosure.

Hereinafter, an example of a configuration of a contract support device according to the first example embodiment of the present disclosure will be described in detail with reference to FIG. 1. In the example illustrated in FIG. 1, a contract support device 100 includes a contract information receiving unit 110, a past information extraction unit 120, and an output unit 130.

### Contract Information Receiving Unit 110

The contract information receiving unit 110 receives information on a negotiation partner who is a counterpart in negotiation for a contract of a negotiator and information on a draft contract that is a draft of details of the contract with a negotiation partner.

When the contract is a contract between organizations, each of the negotiator and the negotiation partner is an organization even if a person such as a person in charge of negotiation of the organization or a representative of the organization performs actual negotiation. Similarly, a contract partner to be described later is also an organization. The organization is a company, a department in a company, a government ministry or agency, a department in a government ministry or agency, a local government, a department in a local government, or the like. The information on the negotiation partner is information indicating an organization that is the negotiation partner. At least one of the negotiator and the negotiation partner may be an entity that is an individual who concludes the contract.

The draft contract is, for example, information, such as a type of contract, information on what is provided under the contract (e.g., a provision of an article, a service, or the like and a consideration for the provision), and terms of the contract such as penalty and compensation. In the following description, a type of information included in the draft contract is referred to as an item. In the following description, a content of each type of information included in the draft contract is referred to as a content of an item.

### Past Information Extraction Unit 120

The past information extraction unit 120 extracts, from among past contract documents each of which is a contract document of another contract with a contract partner related to a negotiation partner among contract partners with which a negotiator has already concluded another contract, a past contract document in which a level of a degree of similarity satisfies a criterion, the degree of similarity representing a level of similarity between a content of the past contract document and a content of the draft contract.

The degree of similarity may be represented by, for example, a magnitude of a vector representing a difference between a vector including, as an element, a value obtained by quantifying contents of a plurality of predetermined items extracted from the draft contract and a vector including, as an element, a value obtained by quantifying the contents of the same plurality of predetermined items extracted from the past contract document. The magnitude of the vector is represented by, for example, a square root of a sum of squares of the elements. The magnitude of the vector may be represented by, for example, a sum of the squares of the elements.

The past information extraction unit 120 extracts content of a plurality of predetermined items from a text of the past contract document by using an existing language understanding technology. In a case where the information on the past contract document is information of an image of the past contract document obtained by scanning the past contract document, the past information extraction unit 120 first extracts a text representing the content of the past contract document from the image of the past contract document by using an existing character recognition technology.

The quantification of the contents of the plurality of predetermined items may be performed by an appropriately determined method. In a case where each content of the item is represented by any of a plurality of values (however, the values are not limited to numerical values), numerical values specified in advance are assigned to the plurality of values. The item in this case is what is provided by the negotiator under contract (e.g., a deliverable such as an object, information, labor, software, or an information processing system, money as a consideration for the deliverable, or the like). Then, the value of the content of the item is, for example, a type of the thing provided by the negotiator under the contract. The item in this case may be what is provided by the contract partner under contract (e.g., a deliverable such as an object, information, labor, software, or an information processing system, money as a consideration for the deliverable, or the like). Then, the value of the content of the item may be, for example, a type of the thing provided by the contract partner under the contract. The content of the item may be a level of the contract partner. The content of the item may be, for example, an organization itself, a department in the organization, a department in the department in the organization, or the like. The quantification of the content of the item in such a case may be performed by specifying a numerical value assigned to a value that is the content of the item.

When the content of the item is represented by, for example, a numerical value, the quantification of the content of the item is to convert the numerical value that is the content of the item into a numerical value as a value of an element of a vector. The item whose content is represented by a numerical value is, for example, a quantity of deliverables, frequency of delivery (e.g., only once, the number of times per unit period, and the like), or a length of a period from an order to a due date.

A value range of the quantified content of the item may be set to be the same for a plurality of predetermined items. The value range of the content of the quantified item may be determined, depending on an importance level of the plurality of predetermined items, for example, such that the higher the importance level of the item, the larger the width of the value range of the value representing the content of the quantified item.

The quantification of the contents of the plurality of predetermined items is not limited to these examples.

The contract partner related to the negotiation partner is, for example, an organization that may influence the negotiation partner. The contract partner related to the negotiation partner may be, for example, an organization that has influence over the negotiation partner. The organization that has influence over the negotiation partner is, for example, an organization including the negotiation partner when the negotiation partner is a department in the organization. The organization that has influence over the negotiation partner is, for example, a department that puts under the influence of the agency that is the negotiation partner among the agencies when the negotiation partner is any agency of the agency. The organization that has influence over the negotiation partner is, for example, a department that has control over the organization that is the negotiation partner in a case where the negotiation partner is an organization under the control of any of the departments. The organization that has influence over the negotiation partner is, for example, a local government that has jurisdiction over the organization that is the negotiation partner in a case where the negotiation partner is an organization under the jurisdiction of any of the local governments. It can be said that the relationship between the negotiation partner and the contract partner, which is an organization that has influence over the negotiation partner, is a relationship defined as a relationship which may influence the negotiation partner.

The past information extraction unit 120 may extract, from among the past contract documents in which the level of the degree of similarity satisfies the criterion, a past contract document concluded with a contract partner having a relationship defined as a relationship that may influence the negotiation partner, by using information indicating the relationship between the negotiation partner and the contract partner. In the information indicating the relationship between the negotiation partner and the contract partner, information on the various negotiation partners and the contract partner having a relationship defined as a relationship that may influence each of the various negotiation partners may be defined.

The contract partner related to the negotiation partner may be, for example, the negotiation partner itself. The contract partner related to the negotiation partner is not limited to these examples.

### Output Unit 130

The output unit 130 outputs information on the extracted past contract document. The output unit 130 may output the information on the extracted past contract document to, for example, a display of the contract support device 100. The output unit 130 may output the information on the extracted past contract document to, for example, a device that inputs, to the contract information receiving unit 110, information on the negotiation partner who is the counterpart in negotiation for the contract of the negotiator and information on a draft contract that is a draft of the details of the contract with the negotiation partner. The device that inputs the information on the negotiation partner who is the counterpart in negotiation for the contract of the negotiator and the information on the draft contract that is the draft of the details of the contract with the negotiation partner to the contract information receiving unit 110 is, for example, an information processing device of a member of the negotiator. The output unit 130 may output the information on the extracted past contract document to, for example, another information processing device that is communicably connected to the contract support device 100. The output unit 130 may output the information on the extracted past contract document to, for example, a storage device that is communicably connected to the contract support device 100.

### Operation

Next, an operation of the first example embodiment of the present disclosure will be described in detail with reference to the drawings.

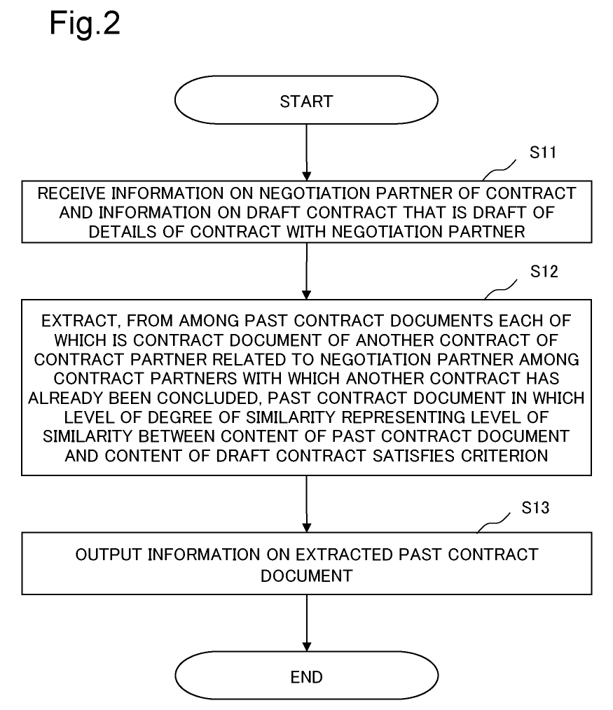

FIG. 2 is a flowchart illustrating an example of the operation of the contract support device according to the present disclosure.

Hereinafter, an example of the operation of the contract support device 100 according to the first example embodiment of the present disclosure will be described in detail using FIG. 2.

The contract information receiving unit 110 receives information on the negotiation partner of the contract and information on a draft contract that is a draft of the details of the contract with the negotiation partner (step S11). The past information extraction unit 120 extracts, from among past contract documents each of which is a contract document of another contract of a contract partner related to the negotiation partner among the contract partners with which another contract has already been concluded, a past contract document in which a level of a degree of similarity representing a level of similarity between the content of the past contract document and content of the draft contract satisfies the criterion (step S12). The output unit 130 outputs the information on the extracted past contract document (step S13).

### Effects

The present example embodiment has an effect of being capable of providing information that may improve the possibility that the counterparty to the contract accepts the modification of the contract.

The reason is that the past information extraction unit 120 extracts, from among the past contract documents each of which is the contract document of another contract of the contract partner related to the negotiation partner among the contract partners with which another contract has already been concluded

the past contract document in which the level of the degree of similarity representing the level of similarity between the content of the past contract document and content of the draft contract satisfies the criterion. This is because the output unit 130 outputs the information on the extracted past contract document.

In general, the details of the contract presented from the negotiation partner may not be accepted as they are. In such a case, it is necessary to negotiate with the negotiation partner to modify the details of the contract. It is considered that the negotiation partner is likely to accept the request if it is a request for making a modification that brings the draft contract closer to the content of the past contract document that is the contract document of another contract of the contract partner related to the negotiation partner. Among the past contract documents each of which is the contract document of another contract of the contract partner related to the negotiation partner, information on the past contract document having a high level of similarity with content of the draft contract may be used as a material for negotiation. In other words, in a case where negotiation for a modification that brings the details of the contract closer to the content of the past contract document is performed after such information on the past contract document is presented, the possibility that the negotiation partner accepts the modification in the details of the contract may be improved as compared with a case where the negotiation is performed without presenting any information. Among the past contract documents each of which is the contract document of another contract of the contract partner related to the negotiation partner, information on the past contract document having a high level of similarity with the content of the draft contract may improve the possibility that the negotiation partner (that is, the counterparty to the contract) accepts the modification of the contract.

### Second Example Embodiment

Next, a second example embodiment of the present disclosure will be described in detail with reference to the drawings. At least a part of the second example embodiment of the present disclosure and at least a part of each modification of the second example embodiment described later can be applied to other example embodiments and other modifications.

### Configuration

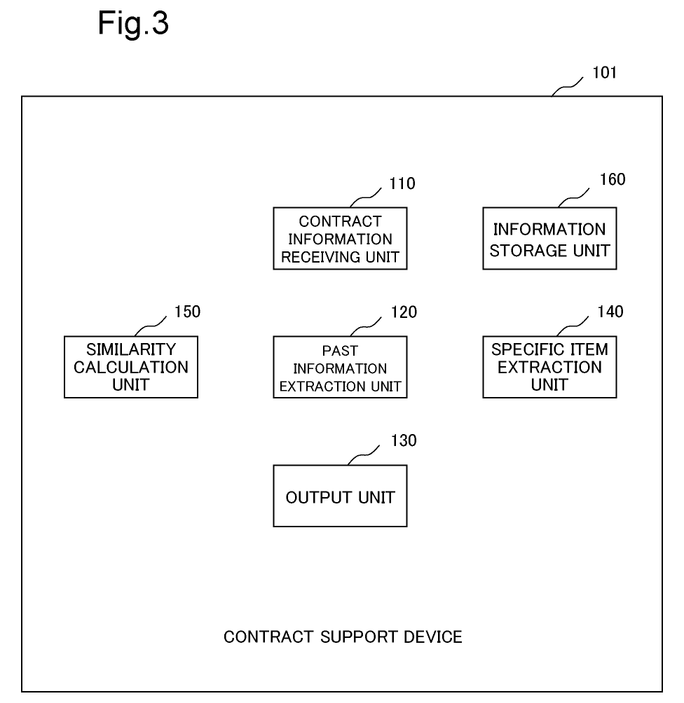

FIG. 3 is a block diagram illustrating an example of a configuration of a contract support device according to the present disclosure.

Hereinafter, an example of a configuration of a contract support device according to the second example embodiment of the present disclosure will be described in detail with reference to FIG. 3. In the example illustrated in FIG. 3, the contract support device 101 includes a contract information receiving unit 110, a past information extraction unit 120, an output unit 130, a specific item extraction unit 140, a similarity calculation unit 150, and an information storage unit 160. The contract information receiving unit 110, the past information extraction unit 120, and the output unit 130 of the present example embodiment are the same as the contract information receiving unit 110, the past information extraction unit 120, and the output unit 130 of the first example embodiment except for differences in the following description.

### Contract Information Receiving Unit 110

The contract information receiving unit 110 receives information on a negotiation partner who is a counterpart in negotiation for a contract of a negotiator and information on a draft contract that is a draft of details of the contract with a negotiation partner.

### Similarity Calculation Unit 150

The similarity calculation unit 150 calculates a degree of similarity representing a level of similarity between the content of the past contract document and content of the draft contract.

The similarity calculation unit 150 may calculate the degree of similarity between the content of the past contract document excluding the content of the specific item and content of the draft contract excluding the content of the specific item. In other words, the similarity calculation unit 150 may calculate the degree of similarity between the past contract document and the draft contract by using the content of an item other than the content of the specific item among the plurality of items. Specifically, the similarity calculation unit 150 may calculate the degree of similarity between the content of an item other than the specific item among the plurality of items extracted from the content of the past contract document and the content of an item other than the specific item among the plurality of items extracted from content of the draft contract.

The specific item is, for example, an item that is specified as an item for which it is desired to request the negotiation partner to modify its content, among items included in the draft contract. The specific item may be determined in advance. The specific item may be, for example, compensation in a case where a defect is found in the deliverables. The specific item may be another item.

### Past Information Extraction Unit 120

The past information extraction unit 120 extracts, from among past contract documents each of which is a contract document of another contract with a contract partner related to a negotiation partner among contract partners with which a negotiator has already concluded another contract, a past contract document in which a level of a degree of similarity satisfies a criterion, the degree of similarity representing a level of similarity between a content of the past contract document and a content of the draft contract.

When a plurality of past contract documents is extracted, the past information extraction unit 120 may extract a past contract document in which the content of the specific item is most advantageous to the negotiator from the plurality of extracted past contract documents. In this case, specifically, for example, the past information extraction unit 120 determines the degree of advantage of the content of the specific item of each of the plurality of extracted past contract documents according to a method, specified in advance, of calculating the degree of advantage indicating the degree of advantage of the content of the specific item for the negotiator. Then, the past information extraction unit 120 specifies the past contract document indicating that the degree of advantage of the content of the specific item is most advantageous for the negotiator from the plurality of extracted past contract documents.

### Information Storage Unit 160

The information storage unit 160 stores information on a contract partner who has concluded a contract in the past and information on a past contract document representing the details of the contract concluded with the contract partner.

The information storage unit 160 may further store information on a draft contract first presented by the contract partner and information on negotiation materials used for negotiation, in the negotiation of the contract indicated by the past contract document. The negotiation material used in the negotiation includes documents such as past contract documents presented to the contract partners in the negotiation, information on provisions of laws and regulations, information on documents disclosed by organizations such as public organizations, and the like.

### Specific Item Extraction Unit 140

The specific item extraction unit 140 extracts the content of the specific item from the past contract document.

The specific item extraction unit 140 extracts the content of the specific item from a text of the past contract document by using an existing language understanding technology. In a case where information on the past contract document is information of an image of the past contract document obtained by scanning the past contract document, the specific item extraction unit 140 first extracts a text representing the content of the past contract document from the image of the past contract document by using an existing character recognition technology.

The specific item extraction unit 140 may receive the content of the specific item among the content of the plurality of items extracted by the past information extraction unit 120 from the past information extraction unit 120.

### Output Unit 130

The output unit 130 outputs information on the extracted past contract document.

The output unit 130 may output the content of the specific item extracted from the past contract document as the information on the extracted past contract document. The output unit 130 may modify the display mode of the content of the specific item extracted from the past contract document in the information on the past contract document. The display mode is one of character modification (For example, one of bold, italic, underlined, and the like), a color of a character, a font of a character, a color and a pattern of a background of a character, and the like. The output unit 130 may output, as the information on the extracted past contract document, the information on the past contract document in which the display mode of the content of the specific item extracted from the past contract document is modified. The output destination of the output unit 130 to which the above information is output is similar to the output destination to which the output unit of the first example embodiment outputs the information.

### Operation

Next, an operation of the contract support device according to the second example embodiment of the present disclosure will be described in detail with reference to the drawings.

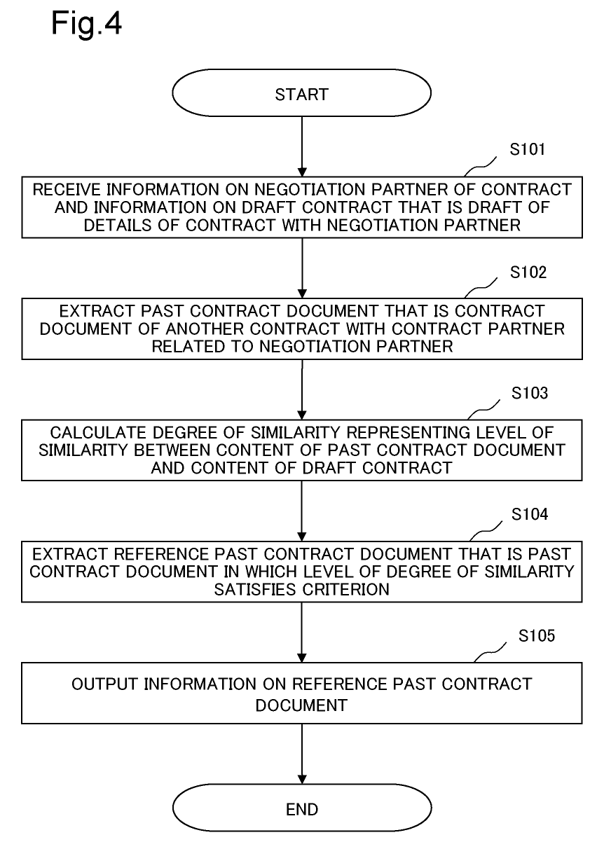

FIG. 4 is a flowchart illustrating an example of the operation of the contract support device according to the present disclosure.

Hereinafter, an example of the operation of the contract support device 100 according to the second example embodiment of the present disclosure will be described in detail using FIG. 4. In the example illustrated in FIG. 4, the contract information receiving unit 110 receives information on the negotiation partner of the contract and information on a draft contract that is a draft of the details of the contract with the negotiation partner (step S101). The past information extraction unit 120 extracts a past contract document that is a contract document of another contract with the contract partner related to the negotiation partner (step S102). The similarity calculation unit 150 calculates the degree of similarity representing the level of similarity between the content of the past contract document and content of the draft contract (step S103). In step S103, the similarity calculation unit 150 calculates the degree of similarity by using the contents of the plurality of items except for the specific item. The past information extraction unit 120 extracts a reference past contract document that is the past contract document in which the level of the degree of similarity satisfies the criterion (step S104). The output unit 130 outputs the information on the reference past contract document (step S105).

Before step S105, the specific item extraction unit 140 may extract the content of the specific item from the extracted past contract document. Then, in step S105, the output unit 130 may output information on the content of the specific item of the past contract document as the information on the extracted past contract document. In step S105, the output unit 130 may output, as the information on the extracted past contract document, information on the past contract document in which the content of the specific item of the past contract document is represented in a mode different from other portions.

### Effects

The present example embodiment has the effect same as that of the first example embodiment. The effect is achieved for the same reason that the effect of the first example embodiment is achieved.

### First Modification of Second Example Embodiment

Next, a first modification of the second example embodiment of the present disclosure will be described.

### Configuration

The configuration of the contract support device according to the present modification is the same as the configuration of the contract support device 101 according to the second example embodiment of the present disclosure illustrated in FIG. 3. The contract support device 101 of the present modification is the same as the contract support device 101 according to the second example embodiment of the present disclosure except for differences in the following description.

### Information Storage Unit 160

The information storage unit 160 further stores information on an original draft contract that is a draft contract first presented by the contract partner who is a counterparty to another contract, in the another contract based on the past contract document.

The information storage unit 160 may store the original draft contract including presentation information that is information presented to the contract partner in the negotiation with the contract partner of the past contract document in the process of modifying the original draft contract to the content of the past contract document.

### Past Information Extraction Unit 120

In another contract based on the past contract document in which a level of a degree of similarity representing a level of similarity between the content of the past contract document and content of the draft contract satisfies the criteria, the past information extraction unit 120 extracts information on an original draft contract that is a draft contract presented first by a contract partner who is a counterparty to another contract. The information on the original draft contract may include information on the original draft contract itself and presentation information that is information presented to the contract partner in the negotiation with the contract partner of the past contract document in the process of modifying the original draft contract to the content of the past contract document.

### Specific Item Extraction Unit 140

The specific item extraction unit 140 extracts the content of the specific item from the extracted past contract document and the original draft contract of the past contract document.

The difference between the original draft contract and the past contract document (For example, modification from the content of the specific item of the original draft contract to the content of the specific item of the past contract document) can be said to be a modification that may be achieved by negotiation.

### Output Unit 130

The output unit 130 outputs the information on the extracted past contract document and the information on the original draft contract of the past contract document. The output unit 130 may output information indicating the extracted past contract document itself and information indicating the original draft contract of the past contract document itself. The output unit 130 outputs, as the information on the extracted past contract document and the information on the original draft contract of the past contract document, information on the specific item extracted from the past contract document and information on the specific item extracted from the original draft contract of another contract based on the past contract document. The output unit 130 may output information on the original draft contract further including presentation information that is information presented to the contract partner in the negotiation with the contract partner of the past contract document in the process of modifying the original draft contract to the content of the past contract document.

### Operation

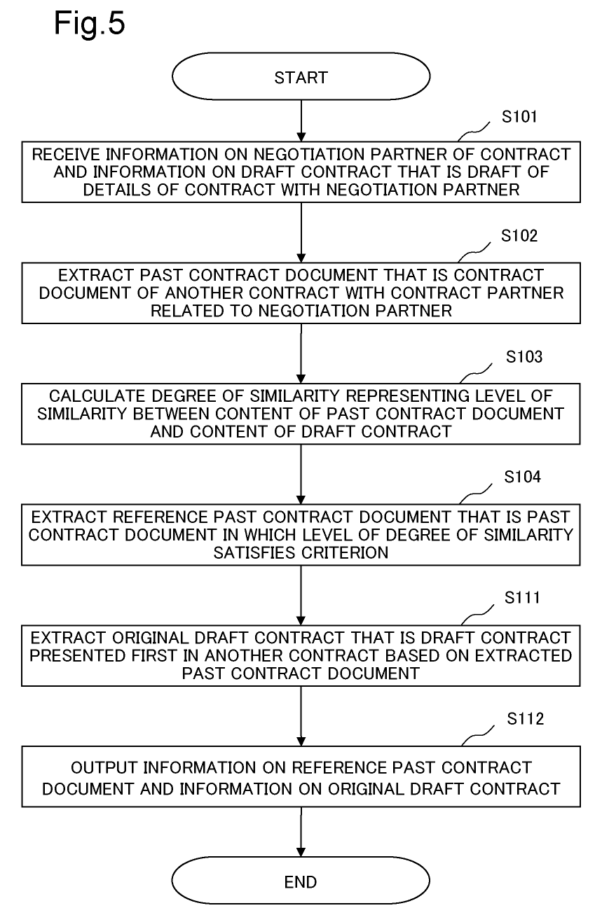

FIG. 5 is a flowchart illustrating an example of an operation of the contract support device according to the present disclosure.

An example of the operation of the contract support device according to the present modification will be described below in detail with reference to FIG. 5. In the example illustrated in FIG. 5, the contract support device 101 of the present modification performs the operation in steps S101 to S104. The operation in step S101 to step S104 is the same as the operation in step S101 to step S104 of the contract support device 101 according to the second example embodiment of the present disclosure illustrated in FIG. 4.

Next, the past information extraction unit 120 extracts an original draft contract that is a draft contract presented first in another contract based on the extracted past contract document (step S111). Then, the output unit 130 outputs the information on the past contract document in which the level of the degree of similarity satisfies the criteria and the information on the original draft contract (step S112).

After step S111, the specific item extraction unit 140 may extract the content of the specific item from the extracted past contract document and the original draft contract of the past contract document. Then, in step S112, the output unit 130 may output the content of the specific item extracted from the past contract document and the content of the specific item extracted from the original draft contract as the information on the past contract document in which the level of the degree of similarity satisfies the criterion and the information on the original draft contract.

### Second Modification of Second Example Embodiment

Next, a second modification of the second example embodiment of the present disclosure will be described in detail with reference to the drawings.

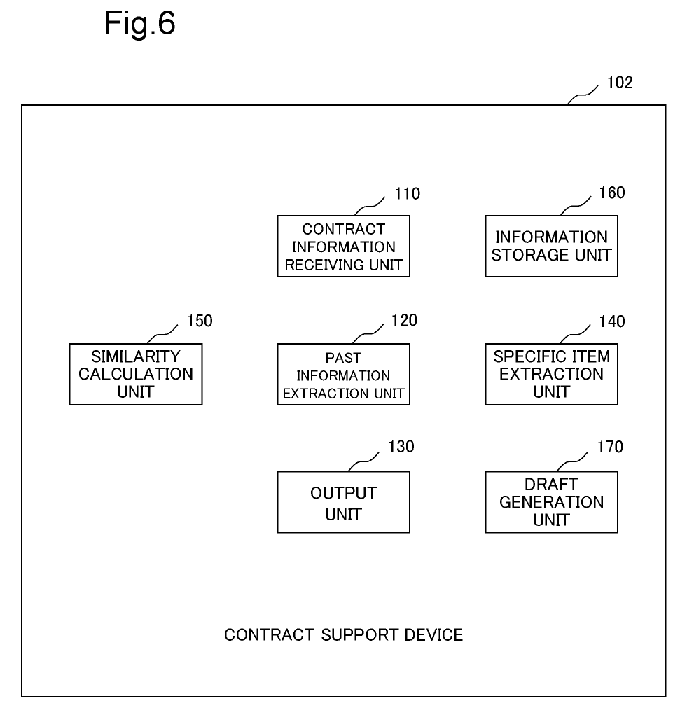

FIG. 6 is a block diagram illustrating an example of a configuration of a contract support device according to the present disclosure. In the example illustrated in FIG. 6, the contract support device 102 includes a contract information receiving unit 110, a past information extraction unit 120, an output unit 130, a specific item extraction unit 140, a similarity calculation unit 150, an information storage unit 160, and a draft generation unit 170. The contract information receiving unit 110, the past information extraction unit 120, the output unit 130, the specific item extraction unit 140, and the similarity calculation unit 150 of the present example embodiment are the same as the contract information receiving unit 110, the past information extraction unit 120, the output unit 130, the specific item extraction unit 140, and the similarity calculation unit 150 of the second example embodiment except for differences in the following description. The contract support device 102 of the present modification is the same as the contract support device 101 of the second example embodiment except for differences in the following description.

### Draft Generation Unit 170

The draft generation unit 170 generates, from a modified draft contract, the draft of the contract document of the contract with the negotiation partner, the modified draft contract being the draft contract in which the specific draft item information that is the information on the specific item of the draft contract is replaced with the past specific item information. Specifically, the draft generation unit 170 first generates the modified draft contract that is the draft contract in which the specific draft item information that is the information on the specific items of the draft contract is replaced with the past specific item information. The draft generation unit 170 generates a draft contract document, which is a draft agreement, from the modified draft contract using the information on the negotiation partner.

The draft generation unit 170 may generate the draft contract document by incorporating the information on the negotiation partner and the information on the modified draft contract into a template of the contract document prepared in advance. The draft generation unit 170 may generate the draft contract document by using a draft contract document generation model (for example, a large-scale language model) trained to generate the draft contract document from the information on the negotiation partner and the information on the modified draft contract. In this case, specifically, the draft generation unit 170 inputs, to the draft contract document generation model, information on the negotiation partner, information on the modified draft contract, and an instruction to generate the draft contract document from the information on the negotiation partner and the information on the modified draft contract. The draft contract document generation model generates a draft contract document in accordance with an instruction and outputs the generated draft contract document. The draft generation unit 170 receives the draft contract document generated by the draft contract document generation model from the draft contract document generation model.

### Operation

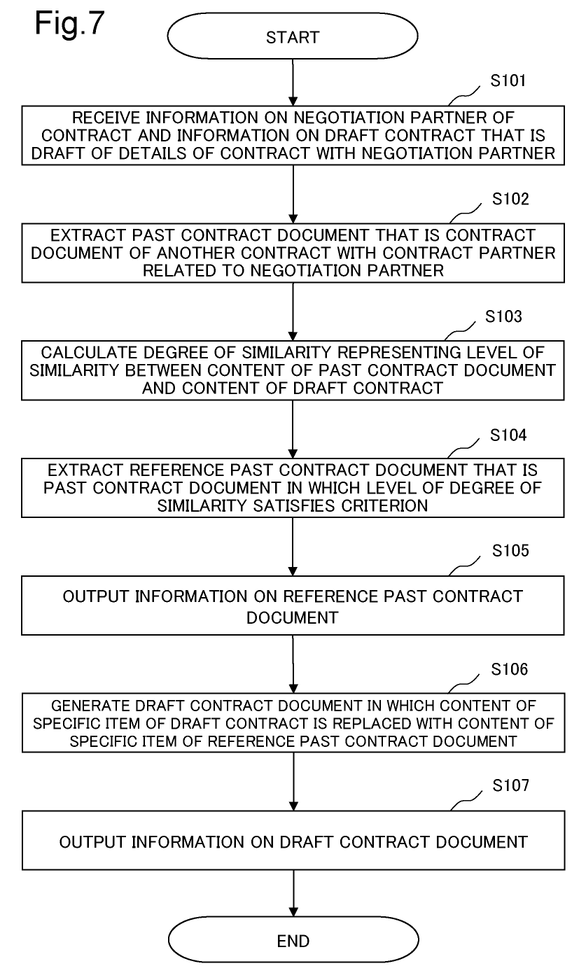

FIG. 7 is a flowchart illustrating an example of an operation of the contract support device according to the present disclosure.

An example of the operation of the contract support device according to the present modification will be described below in detail with reference to FIG. 7. In the example illustrated in FIG. 7, the contract support device 102 of the present modification performs the operation in steps S101 to S105. The operation in steps S101 to S105 of the contract support device 102 illustrated in FIG. 7 is the same as the operation in steps S101 to S105 of the contract support device 101 of the second example embodiment illustrated in FIG. 2.

Next, the draft generation unit 170 generates a draft contract document in which the content of the specific item of the draft contract is replaced with the content of the specific item of the reference past contract document (step S106). Then, the output unit 130 outputs information on the draft contract document (step S107).

### Third Modification of Second Example Embodiment

Next, a third modification of the second example embodiment of the present disclosure will be described in detail with reference to the drawings.

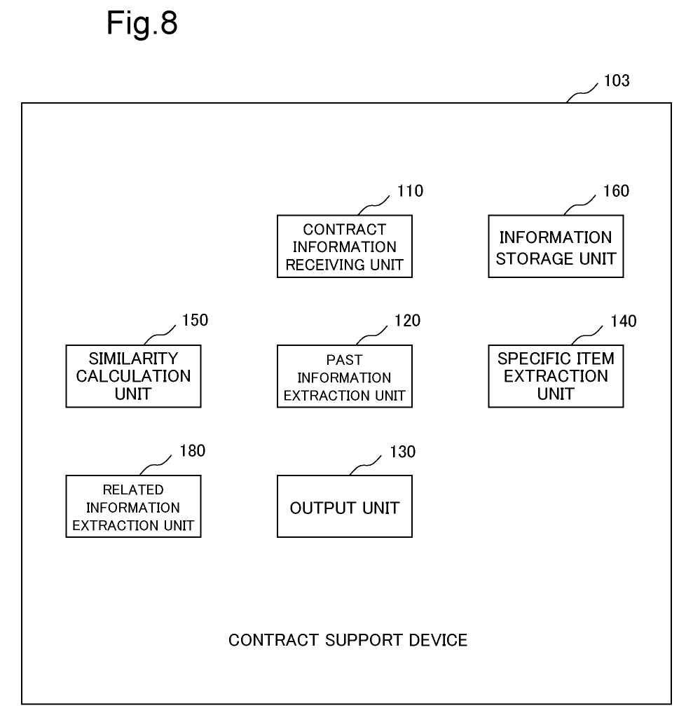

FIG. 8 is a block diagram illustrating an example of a configuration of a contract support device according to the present disclosure. In the example illustrated in FIG. 8, the contract support device 103 includes a contract information receiving unit 110, a past information extraction unit 120, an output unit 130, a specific item extraction unit 140, a similarity calculation unit 150, an information storage unit 160, and a related information extraction unit 180. The contract information receiving unit 110, the past information extraction unit 120, the output unit 130, the specific item extraction unit 140, and the similarity calculation unit 150 of the present example embodiment are the same as the contract information receiving unit 110, the past information extraction unit 120, the output unit 130, the specific item extraction unit 140, and the similarity calculation unit 150 of the second example embodiment except for differences in the following description. The contract support device 103 of the present modification is the same as the contract support device 101 of the second example embodiment except for differences described below.

### Contract Information Receiving Unit 110

The contract information receiving unit 110 of the present modification may further receive information indicating a specific item.

For example, the output unit 130 may output the information indicating each of the plurality of items as the information indicating the candidate of the specific item to the device that has input the information on the negotiation partner and the information on the draft contract to the contract information receiving unit 110. Then, the contract information receiving unit 110 receives information indicating a selected item that is an item selected from a plurality of items of which information is output as candidates of the specific item as information indicating the specific item.

### Related Information Extraction Unit 180

The related information extraction unit 180 extracts public specific item information, which is information regarding a specific item, from information disclosed by a public institution via a communication network.

The public institution is, for example, an institution such as a government ministry or agency or an independent administrative agency. The public institution is not limited to these examples. The public specific item information is, for example, a guideline, a guide, an example, a provision of a law, or the like regarding a specific item in a contract. The public specific item information is not limited to these examples. For example, the related information extraction unit 180 may extract the public specific item information by searching for the public specific item information using a search engine accessible via the communication network and acquiring information obtained by the search via the communication network. The public specific item information for each specific item may be given to the contract support device 103 in advance. In this case, the public specific item information for each specific item is stored in the information storage unit 160. For example, the related information extraction unit 180 extracts the public specific item information on the specific item from the public specific item information stored in the information storage unit 160. The public specific item information may be a basis for requesting the negotiation partner to modify the content of the specific item of the draft contract when the content of the specific item of the draft contract is different from the public specific item information.

### Operation

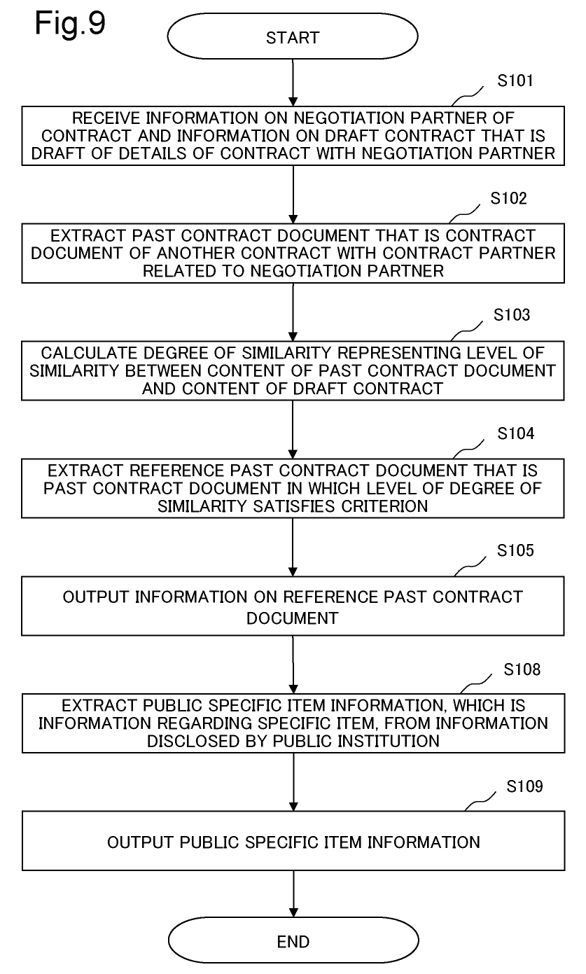

FIG. 9 is a flowchart illustrating an example of an operation of the contract support device according to the present disclosure.

An example of the operation of the contract support device 103 according to the present modification will be described below in detail using FIG. 9. In the example illustrated in FIG. 9, the contract support device 103 of the present modification first performs the operation in steps S101 to S105. The operation in steps S101 to S105 of the contract support device 103 according to the present modification is the same as the operation in steps S101 to S105 of the contract support device 101 according to the second example embodiment of the present disclosure illustrated in FIG. 4.

Next, the related information extraction unit 180 extracts public specific item information, which is information regarding a specific item, from information disclosed by a public institution (step S108). Then, the output unit 130 outputs the public specific item information (step S109).

### Other Example Embodiments

The contract support device according to the present disclosure (that is, the contract support device according to any of the example embodiments of the present disclosure and the contract support device according to the modification of the second example embodiment of the present disclosure) can be achieved by a computer including a memory loaded with a program read from a storage medium and a processor executing the program. The contract support device according to the present disclosure can also be implemented by dedicated hardware. The contract support device according to the present disclosure can also be implemented by a combination of the above-described computer and dedicated hardware.

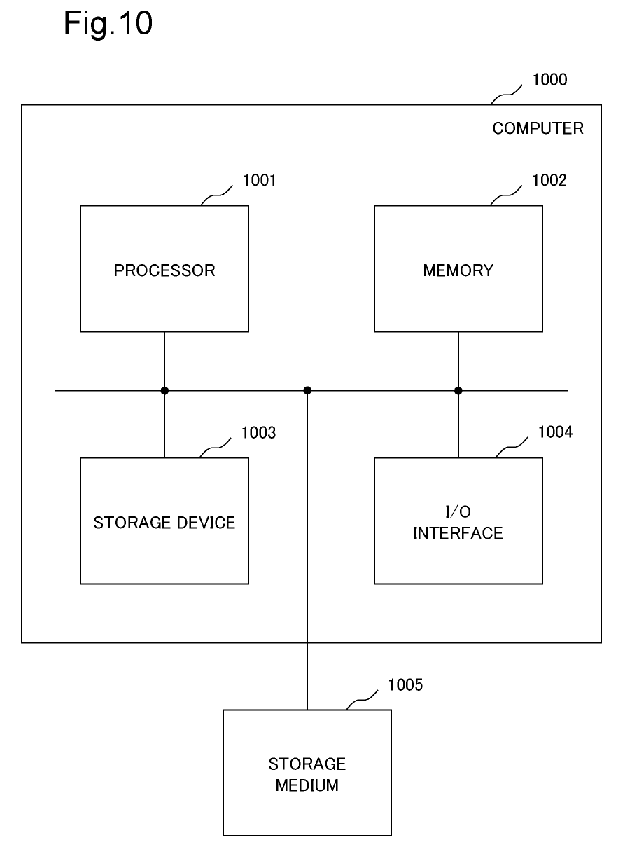

FIG. 10 is a diagram illustrating an example of a hardware configuration of a computer 1000 capable of implementing the contract support device according to the present disclosure. In the example illustrated in FIG. 10, the computer 1000 includes a processor 1001, a memory 1002, a storage device 1003, and an input/output (I/O) interface 1004. The computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and in the memory 1002 and the storage device 1003. The processor 1001 can access, for example, other devices via the I/O interface 1004. The processor 1001 can access the storage medium 1005. The storage medium 1005 stores a program for causing the computer 1000 to operate as the contract support device according to the present disclosure.

The processor 1001 loads a program stored in the storage medium 1005 into the memory 1002, the program causing the computer 1000 to operate as the contract support device according to the present disclosure. Then, the processor 1001 executes the program loaded in the memory 1002 to cause the computer 1000 to operate as the contract support device according to the present disclosure.

The contract information receiving unit 110, the past information extraction unit 120, the output unit 130, the specific item extraction unit 140, the similarity calculation unit 150, and the draft generation unit 170, and the related information extraction unit 180 can be implemented by, for example, the processor 1001 that executes a program loaded in the memory 1002. The information storage unit 160 can be implemented by the memory 1002 included in the computer 1000 or the storage device 1003 such as a hard disk device. Some or all of the contract information receiving unit 110, the past information extraction unit 120, the output unit 130, the specific item extraction unit 140, the similarity calculation unit 150, the information storage unit 160, the draft generation unit 170, and the related information extraction unit 180 can be implemented by a dedicated circuit that implements each function.

For two parties who intend to make a contract, details of the contract presented by one of the two parties are not always acceptable to the other party. In general, the details of the contract are often modified into details acceptable to both parties, through negotiation between the two parties who intend to make the contract. WO 2024/057589 A1 discloses a technique for modifying a content of a contract document representing details of a contract document by using a content of another contract document.

In the technique of WO 2024/057589 A1, it is possible to propose a content of correction of the second contract document different from the first contract document, based on a content of correction of the first contract document. However, the content of the correction of the second contract document is not always acceptable to the counterparty to the contract indicated in the second contract document.

The present disclosure has an effect of being capable of providing the information that may improve the possibility that the counterparty to the contract accepts the modification of the contract.

Some or all of the above example embodiments may be described as the following Supplementary Notes, but are not limited to the following.

### Supplementary Note 1

A contract support device including:
a contract information receiving unit configured to extract information on a negotiation partner who is a counterpart in negotiation for a contract of a negotiator and information on a draft contract that is a draft of details of the contract with the negotiation partner;
a past information extraction unit configured to extract, from among past contract documents each of which is a contract document of another contract with a contract partner related to the negotiation partner among contract partners with which the negotiator has already concluded the another contract, the past contract document in which a level of a degree of similarity satisfies a criterion, the degree of similarity representing a level of similarity between a content of the past contract document and a content of the draft contract; and
an output unit configured to output information on the extracted past contract document.

### Supplementary Note 2

The contract support device according to Supplementary Note 1, including
a specific item extraction unit configured to extract, from the past contract document, a content of a specific item that is an item having been specified, in which
the output is configured to output past specific item information that is information on the content of the specific item in the content of the past contract document as the information on the past contract document.

### Supplementary Note 3

The contract support device according to Supplementary Note 2, including
a draft generation unit configured to generate from a modified draft contract, a draft of a contract document of the contract with the negotiation partner, the modified draft contract being the draft contract in which specific draft item information that is information on the specific item of the draft contract is replaced with the past specific item information, in which
the output unit configured to output the draft of the contract document.

### Supplementary Note 4

The contract support device according to Supplementary Note 1 or 2, in which
the past information extraction unit is configured to extract, from among the past contract documents in which the level of the degree of similarity satisfies the criterion, the past contract document concluded with the contract partner having a relationship defined as the relationship that may influence the negotiation partner in information indicating the relationship between the negotiation partner and the contract partner.

### Supplementary Note 5

The contract support device according to Supplementary Note 2 or 3, including
a related information extraction unit configured to extract, from information disclosed by a public institution, public specific item information that is information regarding the specific item, in which
the output unit is configured to output the extracted public specific item information.

### Supplementary Note 6

The contract support device according to Supplementary Note 2 or 3, in which
the specific item extraction unit is configured to extract the content of the specific item from an original draft contract that is a draft contract first presented by the contract partner who is a counterparty to the another contract in the another contract based on the past contract document, and
the output unit is configured to output information on the specific item extracted from the past contract document and information on the specific item extracted from the original draft contract in the another contract based on the past contract document.

### Supplementary Note 7

The contract support device according to Supplementary Note 2 or 3, in which
the past information extraction unit is configured to extract, from among the past contract documents, the past contract document in which the level of the degree of similarity between the content of the past contract document excluding the content of the specific item and the content of the draft contract excluding the content of the specific item satisfies a criterion.

### Supplementary Note 8

The contract support device according to Supplementary Note 2 or 3, in which
the specific item extraction unit is configured to extract the content of the specific item most advantageous to the negotiator among the contents of the specific item extracted from the past contract documents.

### Supplementary Note 9

The contract support device according to any one of Supplementary Notes 1 to 3, including
a similarity calculation unit configured to calculate the degree of similarity between the content of the past contract document and the content of the draft contract.

### Supplementary Note 10

The contract support device according to Supplementary Note 2 or 3, including
a similarity calculation unit configured to calculate the degree of similarity between the content of the past contract document excluding the content of the specific item and the content of the draft contract excluding the content of the specific item.

### Supplementary Note 11

A negotiation support method including:
receiving information on a negotiation partner who is a counterpart in negotiation for a contract of a negotiator and information on a draft contract that is a draft of details of the contract with the negotiation partner;
extracting, from among past contract documents each of which is a contract document of another contract with a contract partner related to the negotiation partner among contract partners with which the negotiator has already concluded the another contract, the past contract document in which a level of a degree of similarity satisfies a criterion, the degree of similarity representing a level of similarity between a content of the past contract document and a content of the draft contract; and
outputting information on the extracted past contract document.

### Supplementary Note 12

The negotiation support method according to Supplementary Note 11, further including:
extracting, from the past contract document, a content of a specific item that is an item having been specified; and
outputting, as the information on the past contract document, past specific item information that is information on the content of the specific item in the content of the past contract document.

### Supplementary Note 13

The negotiation support method according to Supplementary Note 12, further including:
generating, from a modified draft contract, a draft of a contract document of the contract with the negotiation partner, the modified draft contract being the draft contract in which specific draft item information that is information on the specific item of the draft contract is replaced with the past specific item information; and
outputting the draft of the contract document.

### Supplementary Note 14

The negotiation support method according to Supplementary Note 11 or 12, further including
extracting, from among the past contract documents in which the level of the degree of similarity satisfies the criterion, the past contract document concluded with the contract partner having a relationship defined as the relationship that may influence the negotiation partner in information indicating the relationship between the negotiation partner and the contract partner.

### Supplementary Note 15

The negotiation support method according to Supplementary Note 12 or 13, further including:
extracting, from information disclosed by a public institution, public specific item information that is information regarding the specific item; and
outputting the extracted public specific item information.

### Supplementary Note 16

The negotiation support method according to Supplementary Note 12 or 13, further including:
extracting the content of the specific item from an original draft contract that is a draft contract first presented by the contract partner who is a counterparty to the another contract in the another contract based on the past contract document, and
outputting information on the specific item extracted from the past contract document and information on the specific item extracted from the original draft contract in the another contract based on the past contract document.

### Supplementary Note 17

The negotiation support method according to Supplementary Note 12 or 13, further including
extracting, from among the past contract documents, the past contract document in which the level of the degree of similarity between the content of the past contract document excluding the content of the specific item and the content of the draft contract excluding the content of the specific item satisfies a criterion.

### Supplementary Note 18

The negotiation support method according to Supplementary Note 12 or 13, further
including extracting the content of the specific item most advantageous to the negotiator among the contents of the specific item extracted from the past contract documents.

### Supplementary Note 19

The negotiation support method according to any one of Supplementary Notes 11 to 13, further including
calculating the degree of similarity between the content of the past contract document and the content of the draft contract.

### Supplementary Note 20

The negotiation support method according to Supplementary Note 12 or 13, further including
calculating the degree of similarity between the content of the past contract document excluding the content of the specific item and the content of the draft contract excluding the content of the specific item.

### Supplementary Note 21

A program for causing a computer to execute processing including:
contract information receiving processing for receiving
information on a negotiation partner who is a counterpart in negotiation for a contract of a negotiator and information on a draft contract that is a draft of details of the contract with the negotiation partner;
past information extraction processing for extracting, from among past contract documents each of which is a contract document of another contract with a contract partner related to the negotiation partner among contract partners with which the negotiator has already concluded the another contract, the past contract document in which a level of a degree of similarity satisfies a criterion, the degree of similarity representing a level of similarity between a content of the past contract document and a content of the draft contract; and
output processing for outputting information on the extracted past contract document.

### Supplementary Note 22

The program according to Supplementary Note 21, for causing a computer to execute
specific item extraction processing for extracting, from the past contract document, a content of a specific item that is an item having been specified, in which
the output processing outputs past specific item information that is information on the content of the specific item in the content of the past contract document as the information on the past contract document.

### Supplementary Note 23

The program according to Supplementary Note 22, for causing a computer to execute
draft generation processing for generating, from a modified draft contract, a draft of a contract document of the contract with the negotiation partner, the modified draft contract being the draft contract in which specific draft item information that is information on the specific item of the draft contract is replaced with the past specific item information, in which
the output processing outputs the draft of the contract document.

### Supplementary Note 24

The program according to Supplementary Note 21 or 22, in which
the past information extraction processing extracts, from among the past contract documents in which the level of the degree of similarity satisfies the criterion, the past contract document concluded with the contract partner having a relationship defined as the relationship that may influence the negotiation partner in information indicating the relationship between the negotiation partner and the contract partner.

### Supplementary Note 25

The program according to Supplementary Note 22 or 23, for causing a computer to execute
related information extraction processing for extracting, from information disclosed by a public institution, public specific item information that is information regarding the specific item, in which
the output processing outputs the extracted public specific item information.

### Supplementary Note 26

The program according to Supplementary Note 22 or 23, in which
the specific item extraction processing extracts the content of the specific item from an original draft contract that is a draft contract first presented by the contract partner who is a counterparty to the another contract in the another contract based on the past contract document, and
the output processing outputs information on the specific item extracted from the past contract document and information on the specific item extracted from the original draft contract in the another contract based on the past contract document.

### Supplementary Note 27

The program according to Supplementary Note 22 or 23, in which
the past information extraction processing extracts, from among the past contract documents, the past contract document in which the level of the degree of similarity between the content of the past contract document excluding the content of the specific item and the content of the draft contract excluding the content of the specific item satisfies a criterion.

### Supplementary Note 28

The program according to Supplementary Note 22 or 23, in which
the specific item extraction processing extracts the content of the specific item most advantageous to the negotiator among the contents of the specific item extracted from the past contract documents.

### Supplementary Note 29

The program according to any one of Supplementary Notes 21 to 23, for causing a computer to execute
a similarity calculation processing for calculating the degree of similarity between the content of the past contract document and the content of the draft contract.

### Supplementary Note 30

The program according to Supplementary Note 22 or 23, for causing a computer to execute
a similarity calculation processing for calculating the degree of similarity between the content of the past contract document excluding the content of the specific item and the content of the draft contract excluding the content of the specific item.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

What is claimed is:

1. A contract support device comprising:
at least one memory storing a set of instructions; and
at least one processor configured to execute the set of instructions to:
receive information on a negotiation partner and information on a draft contract, the negotiation partner being a counterpart in negotiation for a contract of a negotiator, the draft contract being a draft of details of the contract with the negotiation partner;
extract, from among past contract documents, the past contract document in which a level of a degree of similarity satisfies a criterion, each of the past contract documents being a contract document of another contract with a contract partner related to the negotiation partner among contract partners with which the negotiator has already concluded the another contract, the degree of similarity representing a level of similarity between a content of the past contract document and a content of the draft contract; and
output information on the extracted past contract document.

2. The contract support device according to claim 1, wherein
the at least one processor is further configured to execute the set of instructions to:
extract, from the past contract document, a content of a specific item that is an item having been specified; and
output past specific item information that is information on the content of the specific item in the content of the past contract document as the information on the past contract document.

3. The contract support device according to claim 2, wherein
the at least one processor is further configured to execute the set of instructions to:
generate, from a modified draft contract, a draft of a contract document of the contract with the negotiation partner, the modified draft contract being the draft contract in which specific draft item information is replaced with the past specific item information, the specific draft item information being information on the specific item of the draft contract; and
output the draft of the contract document.

4. The contract support device according to claim 1, wherein
the at least one processor is further configured to execute the set of instructions to
extract from among the past contract documents in which the level of the degree of similarity satisfies the criterion, the past contract document concluded with the contract partner having a relationship defined as the relationship that is capable of influencing the negotiation partner in information indicating the relationship between the negotiation partner and the contract partner.

5. The contract support device according to claim 2, wherein
the at least one processor is further configured to execute the set of instructions to:
extract, from information disclosed by a public institution, public specific item information that is information regarding the specific item; and
output the extracted public specific item information.

6. The contract support device according to claim 2, wherein
the at least one processor is further configured to execute the set of instructions to:
extract the content of the specific item from an original draft contract that is a draft contract first presented by the contract partner who is a counterparty to the another contract in the another contract based on the past contract document; and
output information on the specific item extracted from the past contract document and information on the specific item extracted from the original draft contract in the another contract based on the past contract document.

7. The contract support device according to claim 2, wherein
the at least one processor is further configured to execute the set of instructions to
extract, from among the past contract documents, the past contract document in which the level of the degree of similarity between the content of the past contract document excluding the content of the specific item and the content of the draft contract excluding the content of the specific item satisfies a criterion.

8. The contract support device according to claim 2, wherein
the at least one processor is further configured to execute the set of instructions to
extract the content of the specific item most advantageous to the negotiator among the contents of the specific item extracted from the past contract documents.

9. The contract support device according to claim 1, wherein
the at least one processor is further configured to execute the set of instructions to
calculate the degree of similarity between the content of the past contract document and the content of the draft contract.

10. The contract support device according to claim 2, comprising
the at least one processor is further configured to execute the set of instructions to:
calculate the degree of similarity between the content of the past contract document excluding the content of the specific item and the content of the draft contract excluding the content of the specific item.

11. A negotiation support method comprising:
receiving information on a negotiation partner and information on a draft contract, the negotiation partner being a counterpart in negotiation for a contract of a negotiator, the draft contract being a draft of details of the contract with the negotiation partner;
extracting, from among past contract documents, the past contract document in which a level of a degree of similarity satisfies a criterion, each of the past contract documents being a contract document of another contract with a contract partner related to the negotiation partner among contract partners with which the negotiator has already concluded the another contract, the degree of similarity representing a level of similarity between a content of the past contract document and a content of the draft contract; and
outputting information on the extracted past contract document.

12. The contract support method according to claim 11, comprising:
extracting, from the past contract document, a content of a specific item that is an item having been specified; and
outputting past specific item information that is information on the content of the specific item in the content of the past contract document as the information on the past contract document.

13. The contract support method according to claim 12, comprising
generating, from a modified draft contract, a draft of a contract document of the contract with the negotiation partner, the modified draft contract being the draft contract in which specific draft item information is replaced with the past specific item information, the specific draft item information being information on the specific item of the draft contract; and
output the draft of the contract document.

14. The contract support method according to claim 11, comprising
extracting from among the past contract documents in which the level of the degree of similarity satisfies the criterion, the past contract document concluded with the contract partner having a relationship defined as the relationship that is capable of influencing the negotiation partner in information indicating the relationship between the negotiation partner and the contract partner.

15. The contract support method according to claim 12, comprising:
extracting, from information disclosed by a public institution, public specific item information that is information regarding the specific item; and
outputting the extracted public specific item information.

16. The contract support method according to claim 12, comprising
extracting the content of the specific item from an original draft contract that is a draft contract first presented by the contract partner who is a counterparty to the another contract in the another contract based on the past contract document; and
outputting information on the specific item extracted from the past contract document and information on the specific item extracted from the original draft contract in the another contract based on the past contract document.

17. The contract support method according to claim 12, comprising
extracting, from among the past contract documents, the past contract document in which the level of the degree of similarity between the content of the past contract document excluding the content of the specific item and the content of the draft contract excluding the content of the specific item satisfies a criterion.

18. The contract support method according to claim 12, comprising
extracting the content of the specific item most advantageous to the negotiator among the contents of the specific item extracted from the past contract documents.

19. The contract support method according to claim 11, comprising
calculating the degree of similarity between the content of the past contract document and the content of the draft contract.

20. A non-transitory computer readable storage medium storing a program for causing a computer to execute:
contract information receiving processing of receiving information on a negotiation partner and information on a draft contract, the negotiation partner being a counterpart in negotiation for a contract of a negotiator, the draft contract being a draft of details of the contract with the negotiation partner;
past information extraction processing of extracting, from among past contract documents, the past contract document in which a level of a degree of similarity satisfies a criterion, each of the past contract documents being a contract document of another contract with a contract partner related to the negotiation partner among contract partners with which the negotiator has already concluded the another contract, the degree of similarity representing a level of similarity between a content of the past contract document and a content of the draft contract; and
output processing of outputting information on the extracted past contract document.
